(19) United States
(12) Patent Application Publication
(10) Pub. No.: US 2008/0063232 A1
(43) Pub. Date: Mar. 13, 2008

(54) Silicon condenser microphone

(76) Inventor: Chung Dam Song, Seoul (KR)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/899,044

(22) Filed: Sep. 4, 2007

(30) Foreign Application Priority Data
Sep. 9, 2006 (KR) 10-2006-0087095

(51) Int. Cl. H04R 9/08

(52) U.S. Cl. 381/355

(57) ABSTRACT

Provided is a silicon condenser microphone using a case in which a plating layer is formed on a body formed of resin. The silicon condenser microphone includes: a case having a can-shaped resin body with one side open, and a plating layer formed on the body; and a substrate on which a micro electro mechanical system (MEMS) microphone chip and an application-specific integrated circuit (ASIC) chip for processing an electrical signal are mounted, a connection pattern for attaching the case is formed, and the case is attached to the connection pattern using a conductive adhesive. The case may be formed in a cylindrical shape or a rectangular box shape. The plating layer may be formed on an inner surface, an outer surface, or an entire surface of the body and a step may be formed along an inner periphery on an end portion of an opening surface of the body.

### BACKGROUND OF THE INVENTION

1. Field of the Invention

The present invention relates to a silicon condenser microphone, and more particularly, to a silicon condenser microphone using a case in which a plating layer is formed on a case body formed of resin.

2. Description of the Related Art

Condenser microphones are widely used in mobile communication terminals, audio equipment, etc. A typical condenser microphone includes a voltage bias element, a diaphragm/backplate pair configured to form a capacitance varying with a sound pressure, and a junction field effect transistor (JFET) configured to buffer an output signal. Such a typical condenser microphone is fabricated by assembling a diaphragm, a spacer ring, an insulating ring, a backplate, a conductive ring, and a printed circuit board (PCB) within a case, and curling an edge portion of the case.

A curling process is to curl the edge portion of the case with applying a pressure toward the PCB. The curling process has an effect on shapes of end products or sound characteristics. The quality of sound can be poor when sound pressure is conveyed between the case and the PCB if the pressing force applied during the curling process is weak. On the other hand, a curling surface tears or modification of internal components occurs to falsify acoustic sound characteristics when the pressing force applied during the curling procedure is excessive.

To solve these problems, a micro electro mechanical system (MEMS) chip microphone fabricated using a micromachining technology is mounted on the PCB substrate and then the case is welded or attached to the PCB substrate. However, since the case used in the typical condenser microphone is formed in a cylindrical shape or a rectangular box shape and formed of a metal, molding becomes difficult.

### SUMMARY OF THE INVENTION

Accordingly, the present invention is directed to a silicon condenser microphone that substantially obviates one or more problems due to limitations and disadvantages of the related art.

An object of the present invention is to provide a silicon condenser microphone using a case which can be molded and a plating layer which is formed on a body formed of resin so as to prevent electromagnetic waves from being received from the outside.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a silicon condenser microphone, including: a case having a can-shaped body with one side open, the body being formed of a resin, and a plating layer formed on the body; and a substrate on which a micro electro mechanical system (MEMS) microphone chip and an application-specific integrated circuit (ASIC) chip for processing an electrical signal are mounted, a connection pattern for attaching the case is formed, and the case is attached to the connection pattern using a conductive adhesive.

The case may be formed in a cylindrical shape or a rectangular box shape, the plating layer may be formed on an inner surface, an outer surface, or an entire surface of the body, and a step may be formed along an inner periphery on an end portion of an opening surface of the body to insert the PCB substrate into the step.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a cross-sectional view of a silicon condenser microphone in which a plating layer is formed on an inner surface of a case according to an embodiment of the present invention;

FIG. 2 is a cross-sectional view of a silicon condenser microphone in which a plating layer is formed on an outer surface of the case according to an embodiment of the present invention;

FIG. 3 is a cross-sectional view of a silicon condenser microphone in which a plating layer is formed on an entire surface of the case according to an embodiment of the present invention;

FIG. 4 is an exploded perspective view of a rectangular box shaped silicon condenser microphone according to the present invention;

FIG. 5 is an exploded perspective view of a cylindrical silicon condenser microphone according to the present invention;

FIG. 6 is a cross-sectional view of a micro electro mechanical system (MEMS) chip structure of a silicon condenser microphone according to the present invention;

FIG. 7 is a cross-sectional view of a modification example of a silicon condenser microphone according to the present invention;

FIG. 8 is a cross-sectional view of a silicon condenser microphone in which a plating layer is formed on an inner surface of a case according to another embodiment of the present invention;

FIG. 9 is a cross-sectional view of a silicon condenser microphone in which a plating layer is formed on an outer surface of the case according to another embodiment the present invention; and

FIG. 10 is a cross-sectional view of a silicon condenser microphone in which a plating layer is formed on an entire surface of the case according to another embodiment the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, the present invention will be described in detail with reference to the accompanying drawings.

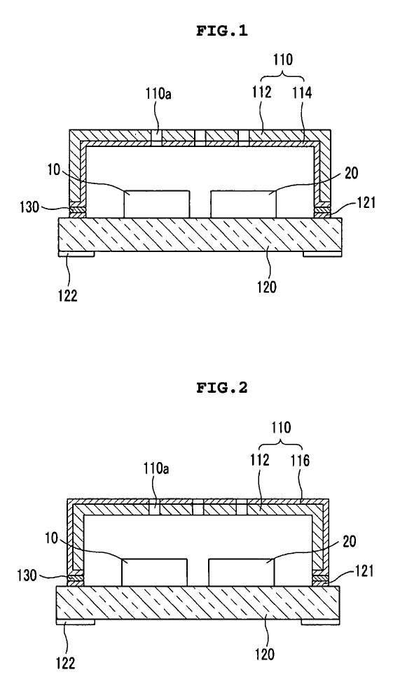

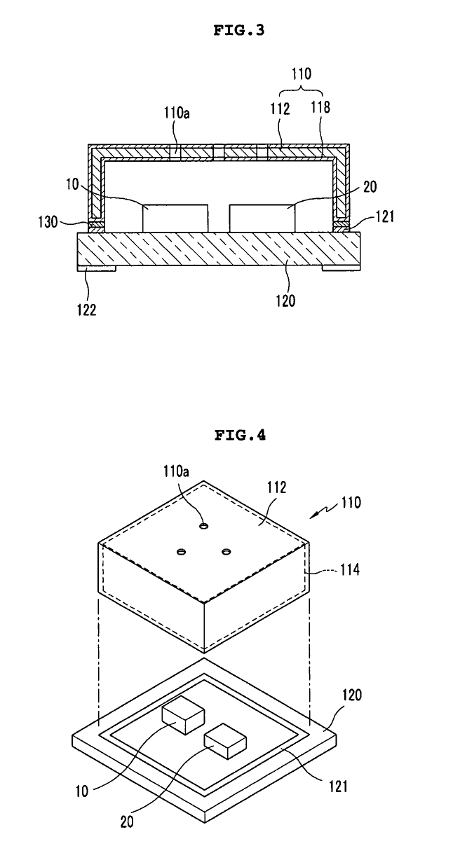

FIG. 1 is a cross-sectional view of a silicon condenser microphone in which a plating layer is formed on an inner surface of a case 110 according to an embodiment of the present invention, FIG. 2 is a cross-sectional view of a silicon condenser microphone in which a plating layer is formed on an outer surface of the case according to an embodiment of the present invention, and FIG. 3 is a cross-sectional view of a silicon condenser microphone in which a plating layer is formed on an entire surface of the case according to an embodiment of the present invention.

Referring to FIGS. 1 to 3, a case 110 of a silicon condenser microphone includes a body 112 formed of resin and a plating layer formed on an inner surface, an outer surface, or an entire surface of the case 110. The plating layer formed on the inner surface is denoted by a reference numeral 114, the plating layer formed on the outer surface is denoted by a reference numeral 116, and the plating layer formed on the entire surface is denoted by a reference numeral 118.

A micro electro mechanical system (MEMS) chip 10 and an application specific integrated circuit (ASIC) chip 20 are mounted on a printed circuit board (PCB) substrate 120. A connection pattern 121 corresponding to a shape of the case 110 is formed on a portion contacted with the case 110.

The case 110 includes the body 112 and plating layers 114, 116 or 118. The body 112 having a can shape is formed of the easily moldable resin and one side of the body 112 is opened. The plating layers 114, 116 and 118 are formed on the inner surface, the outer surface, or the entire surface of the body 112. Therefore, the plating layers 114, 116 and 118 can prevent an electrical connection and electromagnetic waves from being received from the outside. The body 112 may be formed in a cylindrical shape or a rectangular box shape according to the shape of the case 110. A sound hole may be formed according to a sound inflow type. The plating layers 114 and 116 are formed up to an end portion of an opening surface of the case 110 in order to contact the PCB substrate 120 when the plating layers 114 and 116 are formed on one side of the body 112, i.e., the inner surface or the outer surface of the body 112.

A size of the PCB substrate 120 is equal to or greater than that of the case 110. A connection pad or a connection terminal 122 for connecting an external device is disposed on a lateral surface of the PCB substrate 120. The connection pattern 121 is formed by plating nickel (Ni) or gold (Au) after forming a copper film through a general PCB fabrication process. A ceramic substrate, a flexible printed circuit board (FPCB) substrate, and a metal substrate may be used as a substrate besides the PCB substrate 120. The connection pattern 121 may be connected to a ground terminal through a via-hole. The whole case 110 is grounded when the case 110 is connected to the connection pattern using conductive epoxy. Hence, electromagnetic wave noise straying into the case 110 can sink into a ground.

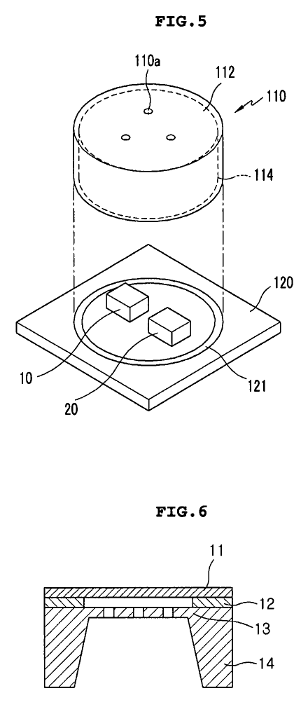

FIG. 4 is an exploded perspective view of a rectangular box shaped silicon condenser microphone according to the present invention, FIG. 5 is an exploded perspective view of a cylindrical silicon condenser microphone according to the present invention, and FIG. 6 is a cross-sectional view of a MEMS chip structure of a silicon condenser microphone according to the present invention.

A silicon condenser microphone according to the present invention can be formed in a rectangular box shaped silicon condenser microphone or a cylindrical silicon condenser microphone. Referring to FIG. 4, in a case where the silicon condenser microphone is formed in the rectangular box shape, a body 112 of a case is formed in the rectangular box shape, and also a connection pattern 121 formed on a PCB substrate is formed in the rectangular box shape. Referring to FIG. 5, in a case where the silicon condenser microphone is formed in the cylindrical shape, a body 112 of a case is formed in the cylindrical shape, and also a connection pattern 121 formed on a PCB substrate is formed in the circular shape.

A case 110 is arrayed on the connection pattern of the PCB substrate 120 and then the case 110 is attached to the PCB substrate 120 using a conductive adhesive 130 to form a silicon condenser microphone package.

Referring to FIGS. 1 to 3, in the packaged silicon condenser microphone assembly, the case 110 is attached to the connection pattern of the PCB substrate 120 using the conductive adhesive 130. A space between the case 110 and the PCB substrate 120 serves as a sound chamber. At least two or more connection terminals 122 for connecting an external device may be formed on a bottom surface of the PCB substrate 120.

Referring to FIG. 6, in a MEMS 10 chip structure, a backplate 13 is formed on a silicon wafer 14 using a MEMS technology and then a diaphragm 11 is formed on spacers 12. Since a fabrication technique of the MEMS chip 10 is well known, further description thereof will be omitted.

A special purpose semiconductor chip 20, e.g., ASIC chip, is connected to the MEMS chip 10 to process electrical signals. The MEMS chip 10 includes a voltage pump and a buffer integrated circuit (IC). The voltage pump provides a voltage such that the MEMS chip 10 operates as a condenser microphone. In the buffer IC, electrical sound signals detected through the MEMS chip are amplified or impedance matched to provide the amplified or impedance matched signals to the outside.

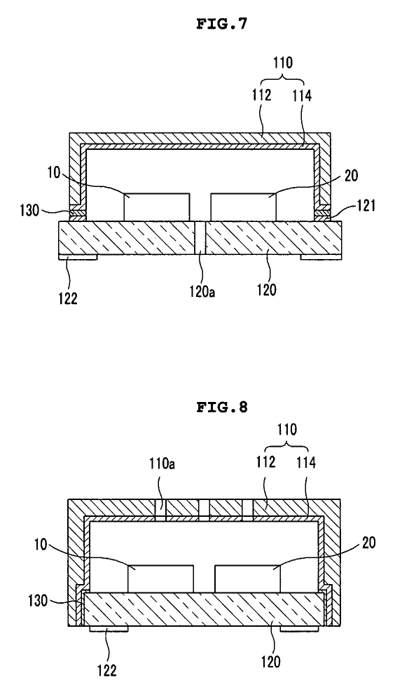

FIG. 7 is a cross-sectional view of a modification example of a silicon condenser microphone according to the present invention. A plating layer may be formed on an inner surface, an outer surface, or an entire surface of a case body 112.

Referring to FIG. 7, a MEMS chip 10 and an ASIC chip 20 are mounted on a PCB substrate 120. A connection pattern 121 is formed on a portion contacted with the case using an adhesive 130. A sound hole 120a for receiving external sound is formed in the PCB substrate 120.

The case 110 includes the body 112 and a plating layer 114. The body 112 formed of easily moldable resin has a can shape. The plating layer 114 formed on an inner surface of the body 112 prevents an electrical connection and electromagnetic waves from being received from the outside. One side of the body 112 is opened and the body may be formed in a cylindrical shape or a rectangular box shape according to the shape of the case 110. The plating layer 114 is formed up to an end portion of an opening surface of the case 110 in order to contact the PCB substrate 120 to the body 112.

The condenser microphone of the modification example is identical to that illustrated in FIGS. 1 to 3, except a location of the sound hole. For this reason, further description thereof will be omitted.

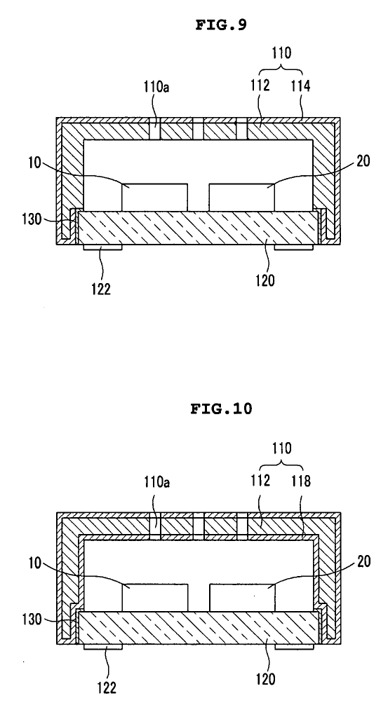

FIG. 8 is a cross-sectional view of a silicon condenser microphone in which a plating layer is formed on an inner surface of a case according to another embodiment of the present invention, FIG. 9 is a cross-sectional view of a silicon condenser microphone in which a plating layer is formed on an outer surface of the case according to another embodiment the present invention, and FIG. 10 is a cross-sectional view of a silicon condenser microphone in which a plating layer is formed on an entire surface of the case according to another embodiment the present invention.

Referring to FIGS. 8 to 10, in a silicon condenser microphone according to another embodiment of the present invention, a step is formed along an inner periphery on an end portion of an opening surface of a case 110 to insert a PCB substrate 120 into the step. The case includes a body 112 and a plating layer. The body includes the step formed along the inner periphery on the end portion of the opening surface of the case 110. The plating layer is formed on an inner surface, an outer surface, or an entire surface of the body 112.

The plating layer formed on the inner surface is denoted by a reference numeral 114, the plating layer formed on the outer surface is denoted by a reference numeral 116, and the plating layer formed on the entire surface is denoted by a reference numeral 118.

The case 110 includes the body 112 and plating layers 114, 116 or 118. The body 112 having a can shape is formed of the easily moldable resin. The plating layers 114, 116 and 118 are formed on the inner surface, the outer surface, or the entire surface of the body 112 to prevent an electrical connection and electromagnetic waves from being received from the outside. The body 112 may be formed in a cylindrical shape or a rectangular box shape according to the shape of the case 110. The step is formed along the inner periphery on the end portion of the opening surface of the case 110 to insert the PCB substrate 120 into the step.

A MEMS chip 10 and an ASIC chip 20 are mounted on the PCB substrate 120. The PCB substrate 120 has a size for being inserted into the step of the case 110. The case is attached to the PCB substrate 120 using an adhesive 130. Also, in case of the silicon condenser microphone according to another embodiment of the present invention, a sound hole may be formed in the case 110 or the PCB substrate 120 according to a sound inflow type.

As described above, in the silicon condenser microphone according to the present invention, the case can be easily formed in various shapes using the resin and the plating layer is formed on the inner, outer, or entire surface of the body to prevent electromagnetic wave noise such as an external noise from being received from the outside.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A silicon condenser microphone, comprising:
a case including a can-shaped body with one side open, the body being formed of a resin, and a plating layer formed on the body; and
a substrate on which a micro electro mechanical system (MEMS) microphone chip and an application-specific integrated circuit (ASIC) chip for processing an electrical signal are mounted, a connection pattern for attaching the case is formed, and the case is attached to the connection pattern using a conductive adhesive.

2. The silicon condenser microphone of claim 1, wherein the case is formed in a cylindrical shape or a rectangular box shape.

3. The silicon condenser microphone of claim 1, wherein the plating layer is formed on an inner surface, an outer surface, or an entire surface of the body, and formed up to an end portion of an opening surface in the case where the plating layer is formed on the inner surface or the outer surface of the body.

4. The silicon condenser microphone of claim 1, wherein the case has a step formed along an inner periphery on the end portion of the opening surface to insert the substrate into the step.

5. The silicon condenser microphone of claim 4, wherein the connection pattern is connected to a ground terminal such that the whole case is grounded to sink electromagnetic wave noise straying in the case into a ground when the connection pattern is connected to the case using the conductive adhesive.
